(19) United States
(12) Patent Application Publication
(10) Pub. No.: US 2026/0347250 A1
(43) Pub. Date: Nov. 5, 2026

(54) Carbon Nanotube-Metal Oxide Hybrid Material for Mortar and Concrete

(71) Applicant: Chasm Advanced Materials, Inc., Canton, MA (US)

(72) Inventor: Ricardo A. Prada-Silvy, Norman, OK (US)

(73) Assignee: Chasm Advanced Materials, Inc., Canton, MA (US)

(21) Appl. No.: 19/412,153

(22) Filed: Dec. 8, 2025

Related U.S. Application Data
(60) Provisional application No. 63/703,978, filed on Oct. 6, 2024.
(60) Provisional application No. 63/901,299, filed on Oct. 17, 2025.

(51) Int. Cl. C04B 14/02; C01B 32/162; C01B 32/168; C04B 14/30; C04B 28/04

(52) U.S. Cl. CPC C04B 14/026; C01B 32/162; C01B 32/168; C04B 14/303; C04B 28/04; C01B 2202/06; C01B 2202/34; C01B 2202/36; C01P 2002/82; C01P 2004/03; C01P 2004/64; C01P 2006/11; C01P 2006/12; C04B 2201/50

(57) ABSTRACT

An additive material for mortar or concrete that includes a dry powder hybrid multiwall carbon nanotube (MWCNT)-metal oxide material having from about 50% to about 90% by weight MWCNT comprising MWCNT bundles having lengths between about 5 microns and 50 microns and diameters between about 0.5 microns and about 5 microns. The MWCNT bundles include individual MWCNTs having diameters from about 7 nm to about 30 nm. The material includes from about 10% to about 50% by weight metal oxide particles. The dry powder hybrid MWCNT-metal oxide material has a tap bulk density of less than about 0.090 g/cc.

### CROSS-REFERENCE TO RELATED APPLICATIONS

This application claims priority of Provisional Application 63/703,978, filed on Oct. 6, 2024, and of Provisional Application 63/901,299, filed on Oct. 17, 2025. The entire disclosures of both priority applications are incorporated by reference herein and for all purposes.

### BACKGROUND

The concrete industry, much like the energy sector, faces increasing environmental and economic pressures due to the high carbon footprint associated with Portland cement, which accounts for approximately 7-8% of global CO₂ emissions. In 2024, worldwide concrete production reached approximately 4.1 billion tons, and an additional 5 billion tons of capacity is projected by 2030, driven mainly by demand growth in Asia and the Middle East. To meet the Net Zero Emissions by 2050 (NZE) scenario, the sector must reduce its CO₂ intensity from 2.8 Gt CO₂ reported in 2022 to about 2.0 Gt CO₂ by 2030, representing roughly a 29% reduction in emissions.

Various strategies have been explored to improve concrete sustainability, including structural design optimization, reduction of cement use through supplementary materials, improvements in kiln efficiency, use of alternative fuels, carbon capture, and electrification based on renewable power. Among these approaches, carbon nanotubes (CNTs) have gained attention due to their ability to enhance mechanical strength properties, reduce cement consumption, improve corrosion resistance, and enable “smart concrete” applications through their electrical conductivity and piezoresistive response. They can also contribute indirectly to CO₂ reduction by lowering clinker consumption, reducing overall cement and binder usage, and decarbonizing electricity when the hydrogen generated during the process is used for power and heat.

However, there are some limitations when integrating CNTs into cementitious materials. The hydrophobic nature of CNTs causes them to form bundles, ropes or agglomerates upon contact with water, making uniform dispersion and distribution within the cement matrix difficult. Experimental methods such as ultrasonication, high-shear mixing, and the use of surfactants have been explored, but these approaches are not commercially scalable and may damage the CNTs, creating structural defects and reducing, significantly their aspect ratio and reinforcement effectiveness.

Dry blending of CNT powders with cement or other pozzolanic additives has also been attempted. Although this method is simpler and more commercially scalable than aqueous-suspension techniques, achieving adequate dispersion and homogeneous distribution of CNTs in the cementitious matrix remains a significant challenge. Additionally, CNT morphology, whether as bundles, cotton-like agglomerates, meshes, carpets, nests, or forests morphologies, strongly influences how they disperse and interact with the calcium silicate and calcium aluminate gels formed during cement hydration. To date, no commercially scalable process has been reported that can physically deagglomerate CNT bundles, enabling homogeneous dispersion and distribution in dry cement blends.

There is a need to develop scalable and safe materials and methods to integrate CNTs into cement using conventional industrial equipment. Materials and methods are also needed that enhance CNT dispersion in dry cement blending, prevent agglomeration during hydration, improve mechanical strength and durability, maintain mixture workability without increasing viscosity, and are economically viable for continuous industrial production, while aligning with the cement industry's CO₂-reduction targets.

### SUMMARY

Disclosed herein are safe and commercially scalable processes for the effective integration of CNTs and CNT-metal oxide hybrid materials into cementitious matrices via dry powder blending. Also disclosed are CNT-metal oxide hybrid materials that can be integrated into cement in a dry state and using standard industrial equipment. In an example this disclosure includes mechanical preconditioning of the dry CNT-metal oxide hybrid material by controlled dry milling or grinding. This preconditioning step is effective to deagglomerate at an industrial scale CNTs with different morphologies (bundles, cotton balls, forests, meshes, etc.) without causing structural damage or operational risks, improving the compatibility between the density and particle size of the preconditioned hybrid material and the cement powder. This facilitates dry powder mixing of the preconditioned hybrid material and the cement powder prior to the hydration reaction caused by the addition of water, preserving the structural integrity and aspect ratio of the CNTs, optimizing mechanical performance (compressive strength, elasticity, and flexural strength), as well as corrosion resistance of concrete made with the preconditioned hybrid material and the cement powder mixture. This enables a fully scalable process using conventional equipment for cement, mortar, concrete, and other cementitious materials. In one aspect an additive material for mortar or concrete that includes a dry powder hybrid multiwall carbon nanotube (MWCNT)-metal oxide material has from about 50% to about 90% by weight MWCNT comprising MWCNT bundles having lengths between about 5 microns and 50 microns and diameters between about 0.5 microns and about 5 microns. The MWCNT bundles include individual MWCNTs having diameters from about 7 nm to about 30 nm. The material includes from about 10% to about 50% by weight metal oxide particles. The dry powder hybrid MWCNT-metal oxide material has a tap bulk density of less than 0.090 g/cc.

In some examples the metal oxide comprises alumina. In some examples the alumina comprises nano-alumina particles. In some examples the dry powder hybrid MWCNT-metal oxide material comprises from about 55% to about 85% MWCNT. In some examples the MWCNT bundles have lengths between about 10 microns and 25 microns. In some examples the MWCNT bundles have diameters between about 1 micron and about 3 microns. In some examples the individual MWCNTs having diameters from about 8 nm to about 15 nm. In some examples the tap bulk density of the dry powder hybrid MWCNT-metal oxide material is less than about 0.040 g/cc. In some examples the tap bulk density of the dry powder hybrid MWCNT-metal oxide material is between about 0.0195 g/cc and about 0.0089 g/cc. In some examples the additive material has a Raman spectroscopy G/D ratio of at least 0.90 using a 532 nm laser and at least 0.70 using a 638 nm laser.

In an example the additive material also includes dry cement powder. In some examples the dry cement powder is mixed with the dry powder hybrid MWCNT-metal oxide material. In some examples this cement-hybrid dry mixture is then mixed with sand and water to create a mortar, wherein the amount of the dry powder hybrid MWCNT-metal oxide material in the mortar is from about 0.05 wt % to about 0.55 wt %. In some examples the cement-hybrid dry mixture is effective to improve at least one of the flexural strength, the modulus of elasticity and the compressive strength of mortar prepared with the cement-hybrid dry additive material as compared to mortar without the cement-hybrid dry additive material. In an example the additive material includes from about 15% to about 30% by weight metal oxide particles.

In another aspect a method for integrating carbon nanotubes (CNT) into cement matrices includes synthesizing multi-wall CNT (MWCNT) using catalysts containing one or more active metals selected from the group of metals including Co, Fe, and Mo supported on a metal-oxide based support and using carbon-containing gas as a carbon source in a rotary tube or fluidized bed reactor, preconditioning a dry powder comprising the synthesized MWCNT by a mechanical grinding process, to deagglomerate and disentangle the synthesized MWCNT, to form more open structures, and dry mixing the preconditioned MWCNT with dry cement particles. The preconditioned MWCNTs are more readily dispersed into a cement matrix, with less energy required to de-bundle and disperse the preconditioned MWCNTs into the cement matrix as compared to the original MWCNTs before preconditioning.

In some examples the MWCNT have a bundle, mesh, cotton ball, or forest morphology. In some examples the mechanical grinding process comprises an industrial powder grinding method. In some examples the mixture of the preconditioned MWCNT with cement particles has improved mechanical properties as compared to mortar. In an example the improved mechanical properties include one or more of the flexural strength, the modulus of elasticity, and the compressive strength. In some examples the mixture of the preconditioned MWCNT with cement particles has improved conductivity properties as compared to mortar. In some examples the metal-oxide based support comprises one or more of alumina, MgO—Al₂O₃, and SiO₂—Al₂O₃. In some examples the metal-oxide based support has a specific surface area of from about 200 to about 400 m²/g. In some examples the synthesized MWCNT has a bundle morphology.

In some examples the preconditioned dry powder comprising the synthesized MWCNT has a tap bulk density of less than about 0.02 g/cc. In some examples the preconditioned dry powder comprising the synthesized MWCNT has a Raman spectroscopy G/D ratio of at least 0.90 using a 532 nm laser and at least 0.70 using a 638 nm laser.

### BRIEF DESCRIPTION OF THE DRAWINGS

FIG. 1. SEM images illustrating results of aspects of methods of integrating dry powder hybrid CNT-metal oxide material into cement powder.

FIG. 2. SEM images of synthesized MWCNTs with different morphologies.

FIG. 3. SEM images taken at 25 K magnification corresponding to hybrid CNT-metal oxide powders synthesized in Example 1, and after 3, 7, and 28 days of hydration reaction time.

FIG. 4. Mechanical properties of carbon nanotubes with different morphologies in cement.

FIG. 5. Effect of grinding the MWCNT-Al₂O₃ hybrid material on the improvement of cement's mechanical strength.

FIG. 6. SEM Images at 15 KX and 25 KX magnifications showing mesh-like CNT morphology integrated into cementitious material after 7 days of curing.

FIG. 7. SEM images showing the effect of CNT content on the morphology and aspect ratio of CNT-metal hydroxide hybrid materials.

FIG. 8. SEM images taken at 1 KX magnification of the MWCNT hybrid materials as produced.

FIG. 9. SEM images at 500 X, 1 KX, and 5 KX magnification comparing the MWCNT hybrid material after purification and subsequent grinding.

FIG. 10. SEM micrographs of the ground and then ball-milled CNT-Al₂O₃ hybrid material mixed with cement at 0.20 wt % MWCNT.

FIG. 11. Raman spectrum of the CNT-Al₂O₃ hybrid material obtained using a 532 nm laser.

### DETAILED DESCRIPTION

The hybrid CNT-metal oxide material produced in the reactor consists of particles that are a few millimeters in size. When these particles are mixed with cement powder, differences in particle size and density hinder proper mixing, causing agglomeration upon contact with water during mortar or concrete preparation. This results in localized inhomogeneities that create material imperfections and may not sufficiently contribute to improvements in the mechanical properties of the final material. These limitations are addressed herein, in part through a mechanical pre-conditioning treatment applied to the material produced in the reactor before dry mixing with cement powder or other cementitious materials.

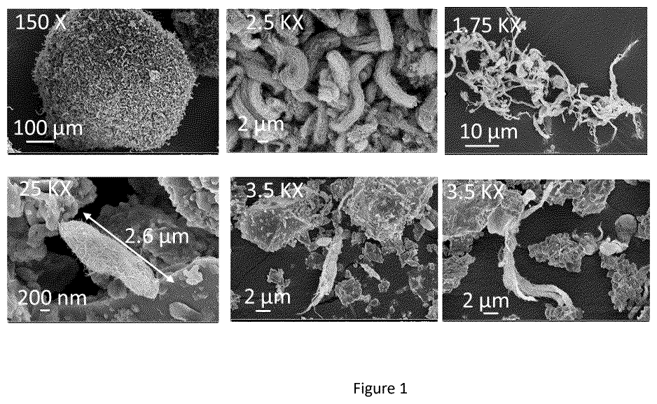

To illustrate a pre-conditioning and dry-blend process, FIG. 1 presents six Scanning Electron Microscopy (SEM) images showing the integration of carbon nanotubes into cement powder. The hybrid CNT-metal oxide material obtained after synthesis consists of granules of CNT-metal oxide hybrid material approximately 1-3 mm in size (see the SEM in the top row at the left). These granules contain CNT bundles longer than 7 μm with bundle diameters between 1 and 3 μm, and individual MWCNTs with diameters of about 10 nm (see bundles in the SEM in the top row in the middle).

In an aspect of this disclosure these CNT-metal oxide hybrid material granules are ground (i.e., mechanically preconditioned) using either conventional grinding equipment (see the SEM in the top row at the right) or a ball mill (see the SEM in the bottom row at the left). The mechanically preconditioned CNT-metal oxide hybrid material is then mixed with cement particles in a high-speed mixer or conventional mortar mixer equipment (see the SEMs in the bottom row in the middle and at the right, respectively).

Under the mechanical shear forces of the preconditioning (e.g., by grinding), the CNT bundles of the hybrid material begin to deagglomerate and disentangle, leading to a significant reduction in tap bulk density, in some cases by a factor of approximately 4 to 6 or more. The grinding and subsequent mixing processes generally do not modify the length or diameter of the CNT bundles, thus maintaining the effectiveness of the CNTs in the cement and in concrete and other cementitious materials. Once the carbon nanotube bundles are disentangled, their size becomes comparable to that of the cement powder (about 5-50 μm). Accordingly, less mechanical energy is needed to separate and disperse the CNT bundles throughout the cementitious matrix during subsequent dry mixing with cement and/or other components of concrete. As a result, individual CNT bundles are distributed uniformly and dispersed among the cement particles.

The size of the bundles is not modified during grinding and mixing. During grinding, the millimeter-scale agglomerates are broken apart into aggregates of individual bundles with micrometer-scale dimensions (see FIG. 1, top right SEM image). During mixing with cement, these micrometer-scale aggregates disentangle, and the individual bundles deposit onto the surface of the cement particles, as shown in FIG. 1, bottom middle and right SEM images.

The mechanical preconditioning step helps to ensure good distribution, homogeneity, and surface contact between the hybrid material and the cement particles during dry mixing and throughout the subsequent hydration reaction of calcium silicates and aluminates compounds.

MWCNT-metal oxide hybrids were synthesized using various catalysts containing Co or combinations of Co, Fe, and/or Mo supported on high-surface-area metal oxides based on Al₂O₃, MgO—Al₂O₃, or SiO₂—Al₂O₃ (200-400 m²/g). The synthesis was carried out in either a rotary tube reactor or a fluidized bed reactor, using ethylene as the carbon source and hydrogen at temperatures between 600 and 750 °C, atmospheric pressure, and a residence time in the reactor's reaction zone of 10-20 minutes. The catalyst preparation method for the Al₂O₃ and MgO—Al₂O₃ support, as well as the CNT hybrid synthesis conditions, are described in WO 2024/173929 A2 and US 2023/0116160 A1, respectively, both of which are incorporated herein in their entireties and for all purposes.

In some examples the carbon nanotube content in the hybrid material ranges from about 15 to about 94 wt %, preferably between 20 and 85 wt % for advanced construction material applications. In some examples the content of MgO—Al₂O₃ and SiO₂—Al₂O₃ support in the catalyst varies between 96 and 99 wt %. In some examples the active metal (e.g., Co and Fe) content ranges from about 1 to about 4 wt %, and in some case up to about 7 wt %. In some examples the catalyst grains have a particle size of less than 500 μm, preferably between 150-500 μm when a fluidized bed reactor is used. In rotary tube reactors, the catalyst can be fed with catalyst particles smaller than 150 microns, which represents an advantage compared to fluidized bed reactors. In some examples the Al₂O₃ supports are agglomerates composed of elementary particles with sizes ranging from 600 to 1500 nm.

During the initial stage of the catalytic reaction, the growth of CNTs causes de-agglomeration of the elementary particles that form the catalyst grains. As the reaction progresses, these elementary particles are dispersed in a three-dimensional open mesh of carbon nanotubes. The morphological properties of the support (shape and size of the particles) as well as the composition of the active phase in the catalyst determine the morphology properties of the carbon nanotubes (bundles, cotton balls, mesh, bird nest, forest, etc.). The more open and less tangled the carbon nanotube morphology is, the easier it is to disperse into cementitious materials with less energy usage in mechanical pre-conditioning and mixing equipment. In some examples the SiO₂—Al₂O₃ support has a lamellar structure with particle sizes smaller than 70 microns. The active metals tend to deposit preferentially between the layers of aluminum silicate. During synthesis, exfoliation of the layers occurs, and carbon nanotubes grow in the form of forests of straight multi-tubes (multiwall CNT or MWCNT) with lengths greater than 200 microns and diameters of 10±3 nm.

In the present CNT-metal oxide hybrid powder materials, CNT bundle lengths of from about 5 microns to about 30 microns (with best results in the 10-25 micron range), CNT bundle diameters from about 0.8 microns to about 5 microns (with best results of no more than about 3 microns), and tap bulk densities in the range of from about 0.0195 g/cc to about 0.0089 g/cc provide for good and easy dry-mix dispersibility in cement and good resulting mechanical properties of the resulting cement. The cement-CNT-metal oxide hybrid powder material can also be dry mixed into other components of concrete (such as sand and aggregate) and with other cementitious materials.

### Example 1: Synthesis of Carbon Nanotubes with Different Morphologies

Carbon nanotubes with different morphologies were synthesized using CoMoFe and Co-based catalysts supported on MgO—Al₂O₃, following preparation methods from U.S. Pat. No. 9,855,551B2 and WO2024173929A2, both of which are incorporated herein in their entireties and for all purposes. The synthesis was conducted in a 3″ diameter quartz rotary tube reactor at 675 °C in continuous mode, with an ethylene gas flow of 20 L/min and a catalyst residence time of 15 minutes.

Additionally, a catalyst was prepared using a natural SiO₂—Al₂O₃ support (Vermiculite) with a lamellar structure. The support was exfoliated by grinding, and metal impurities were removed by treating with 1.5 wt % citric acid at 60 °C for 4 hours under stirring. The resulting support had particle sizes ranging from 300 to 500 microns. An aqueous solution of Co acetate and iron nitrate in a 2:1 Fe/Co atomic ratio was added to the support at 60 °C with stirring for 3 hours, followed by filtration. The impregnated solid was dried at 60 °C for 2 hours, 120 °C for 2 hours, and calcined in air at 400 °C for 3 hours, resulting in a catalyst with a total metal composition of 5.0 wt %.

MWCNT-forest synthesis using 40 grams of CoFe/SiO₂—Al₂O₃ catalyst was carried out in a 3″ diameter fluidized bed reactor with an ethylene flow of 20 l/min at 675 °C for 20 minutes.

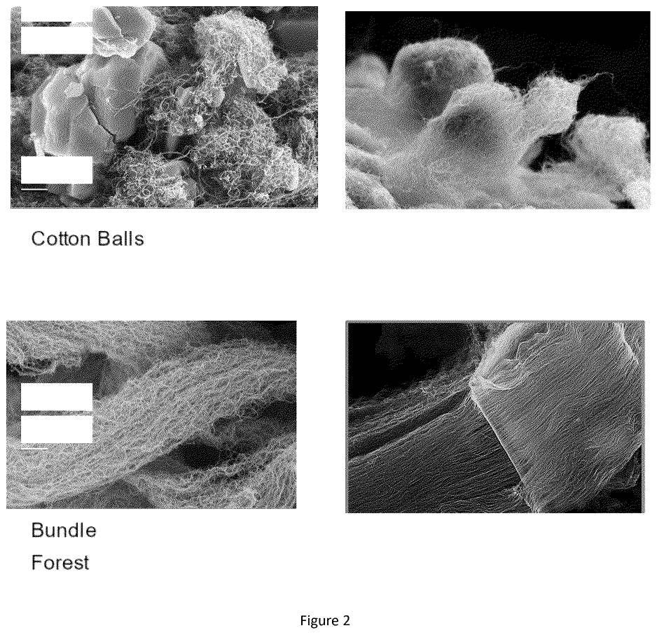

FIG. 2 shows four SEM images of the synthesized CNTs with different morphologies, produced using the CoFe/MgO—Al₂O₃ catalyst (see top left SEM), CoFeMo/MgO—Al₂O₃ catalyst (see top right SEM), Co/Al₂O₃ catalyst (see bottom left SEM), and CoFe/SiO₂—Al₂O₃ catalyst (see bottom right SEM) under the above-described reaction conditions in rotary tube reactor (the CNTs of the top and bottom left SEMs were produced in a fluidized bed reactor).

The morphological properties of catalyst particles (shape, size, porous structure, type and content of active metal) and reactor operating conditions (temperature, gas composition, carbon source, catalyst residence time) determine the type of CNTs synthesized and their morphological characteristics. To form a mesh-like structure, elemental alumina particles smaller than about 5 microns, with low active phase content (about ≤2.0 wt %), and reactor operation at conversion levels below about 30 wt % of deposited MWCNTs are usually best. For cotton ball morphologies, near-spherical catalyst particles, with active metal content higher than about 2 wt %, reaction temperatures around 700 °C, ethylene as the carbon source, and carbon yield above about 30 wt % are usually best. To achieve bundle morphologies, spherical catalyst particles with elemental sizes below about 5 microns, preferably cobalt-based monometallic catalysts with high active phase content (in some cases up to about 7 wt %), are typically used, and the MWCNT content in the product exceeds about 40 wt %. For forest-type MWCNT structures, laminar-shaped catalyst support particles are best, where carbon nanotube growth occurs in a single direction.

The aspect ratio (L/D) of both CNT bundles and individual nanotubes is a factor when mixing the material, whether in powder form or suspensions, with cement particles. Long CNT bundles (>20 microns) tend to agglomerate easily, hindering their integration into the cement matrix during the reaction and hydration of calcium silicates and aluminates. Very short nanotubes (<1 micron) do not significantly improve the mechanical or electrical conductivity properties of the mortar. The lengths of individual CNTs and CNT bundles between about 1 micron and 20 microns are thus preferred for use in cement, cementitious materials, and concrete.

The hybrid CNT-metal oxide material dry disperses in cement and cementitious materials very well when the bundle length is between 8 μm and 15 μm and the bundle diameter is between 1 μm and 3 μm. This corresponds to an approximate bundle aspect ratio in the range of 2.6 to 15. Regarding the aspect ratio of the individual nanotubes, assume that the length of each individual tube is the same as the bundle length, while the tube diameter is 10±3 nm. This results in an approximate aspect ratio for the individual nanotubes ranging from 600 to 2200.

### Example 2: Dispersion of Carbon Nanotubes with Different Morphologies into Cement

In this example, the carbon nanotubes synthesized in Example 1 were integrated into Portland Type I/II cement powder following the previously described procedure, which involved grinding the as-produced material, and then dry blending it with the cement particles (see FIG. 1). The carbon nanotube content in the cement mixture is 0.20 wt %. Water was added to the CNT-cement powder mixture at a ratio of 0.45 grams of water per gram of cement in a mixer, following the procedure described in ASTM standard C305-20, and disc-shaped specimens with a thickness of 12 mm and a diameter of 60 mm were prepared. The dispersion of the carbon nanotubes in the cement specimens at different curing times was analyzed by SEM.

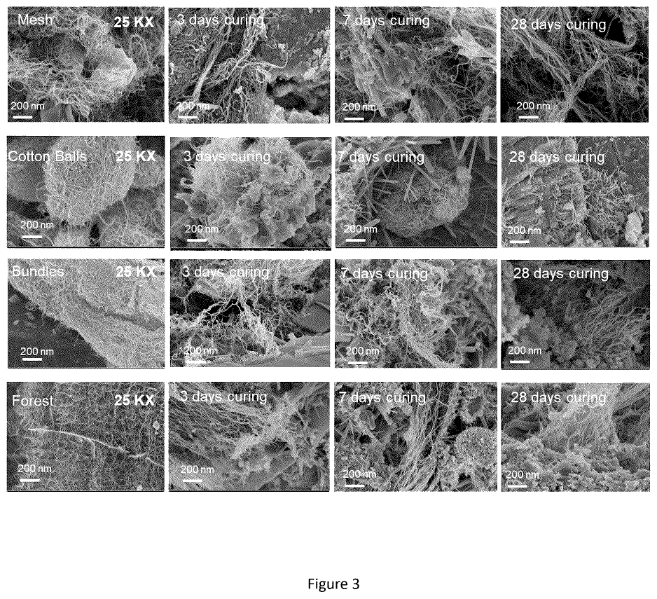

FIG. 3 shows SEM images (all taken at 25K magnification), corresponding to the carbon nanotubes synthesized in Example 1 and after 3, 7, and 28 days of hydration reaction. The top row is the mesh morphology at the left, and 3, 7 and 28 days curing from left to right. The second row from the top is the cotton ball morphology at the left, and 3, 7 and 28 days curing from left to right. The third row from the top is the bundles morphology at the left, and 3, 7 and 28 days curing from left to right. The bottom row is the forest morphology at the left, and 3, 7 and 28 days curing from left to right. It is clearly observed in all samples that during the hydration of calcium silicates and aluminates, a progressive disentanglement and dispersion of the carbon nanotubes occur within the cement matrix.

During the hydration reaction, the pH rises to values close to 12 due to the formation of Ca(OH)₂. Under these conditions, the elemental alumina particles from the catalyst support begin to dissolve and react with Ca²⁺ ions to form calcium aluminate, one of the fundamental components of cement. Simultaneously, the carbon nanotubes tend to concentrate calcium, silicate, and aluminum ions on their surface, acting as nucleating agents and promoting the formation of hydrated calcium silicate and aluminate gels, which crystallize in the spaces between the nanotubes, facilitating their disentanglement. Carbon nanotubes with mesh and bundle morphologies disentangle and disperse more easily than those in the form of forests or cotton-like aggregates. The interaction between the carbon nanotubes and the support particles, as well as the CNT aspect ratio, significantly influences the disentanglement of individual tubes and their dispersion within the cement matrix.

### Example 3: Mechanical Properties of Cements with Carbon Nanotubes with Different Morphologies

The mechanical properties (i.e., flexural strength, modulus of elasticity, and compressive strength) were determined for cement with CNTs with different morphologies. Approximately 15 grams of the carbon nanotubes synthesized in Example 2 (i.e., the dry hybrid CNT-metal oxide material from the reactor) were dry milled/ground using a blade grinder, with a mechanical pre-conditioning time of 12 minutes. The tap bulk density of the carbon nanotubes decreased, reaching values between 0.01 and 0.04 g/cc, as is further described elsewhere herein. The dry milled/ground material was then mixed with dry Portland Type I/II cement powder in a speed mixer for 1 minute at 1250 rpm. The MWCNT content in the cement was 0.20 wt %.

Subsequently, mortar specimens were prepared by mixing the cement containing the different CNT morphologies with sand and water in a 1/2.75/0.5 ratio, respectively. The mechanical properties of the specimens (dimensions 20×20×80 mm for three point bending and 20×20×40 mm for uniaxial compression) were measured after 3, 7, and 28 days of curing, and the results were compared with mortar specimens that did not contain CNTs.

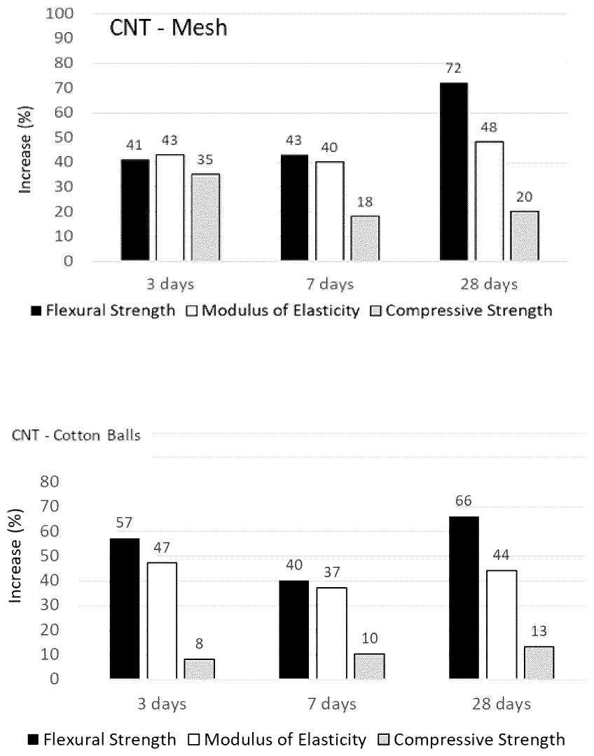

FIG. 4 shows the results of mechanical strength tests for cement blends containing CNTs with mesh (top), cotton ball (middle), and bundle (bottom) morphologies. In all cases, a significant improvement in the mechanical properties of the CNT-cement blends is clearly observed compared to plain mortar. The greatest improvement in all three evaluated properties over the curing period was achieved with carbon nanotubes exhibiting a bundle morphology.

### Example 4: Effect of CNT Dry Milling on Mechanical Property Improvement of Cement

The present example aims to demonstrate effects of dry milling (e.g., grinding) the CNT-metal oxide (e.g., Al₂O₃) hybrid material prior to its dry mechanical incorporation into cement powder. The hybrid CNT-alumina material, as obtained from the rotary tube reactor, has a particle size of approximately 1 to 3 mm, containing bundles of carbon nanotubes (CNTs) with lengths of about 10 to about 15 μm and diameters of about 1 to about 3 μm. This material, when unground, was initially blended with Portland Type I/II cement powder in a high-speed mixer.

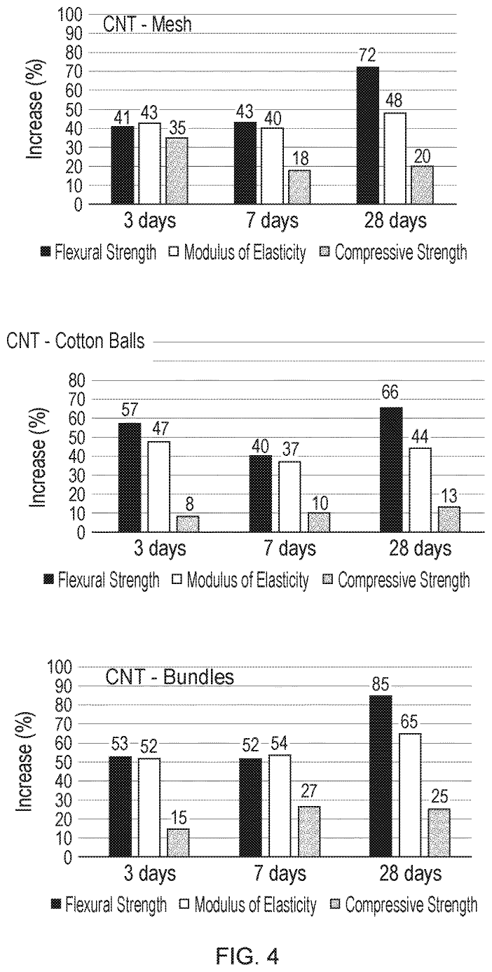

In another preparation, the as-produced hybrid material was subjected to dry milling before being blended with cement powder under the conditions described in Example 3. As illustrated in FIG. 5, the comparison of both preparations, maintaining an identical CNT content in the cement (0.20 wt %), demonstrates that dry milling or grinding the hybrid CNT-metal oxide material before mixing it with cement powder results in significant improvements in flexural strength (top) and modulus of elasticity (middle). Furthermore, a more pronounced increase in compressive strength (bottom) was observed during the first three days of curing.

These results confirm that dry milling/grinding the hybrid material prior to its incorporation into cement enhances the performance of the cementitious composite, clearly distinguishing it from incorporation of the hybrid material in cement without grinding.

### Example 5: Relationship Between the Dispersibility of Carbon Nanotubes and the Improvement of Electro-Mechanical Properties

The present example illustrates the relationship between the dispersibility of carbon nanotubes (CNTs) during the hydration reactions of calcium silicate and calcium aluminate and the improvement of the mechanical properties and corrosion resistance of cement.

To carry out this demonstration, a cylindrical specimen, 12 mm thick and 60 mm in diameter, was prepared by mixing CNTs with a bundle-type morphology and cement powder (with the mixture containing 0.20 wt % CNT) with water, at a ratio of 0.50 g of H₂O per gram of cement, using a conventional mixer.

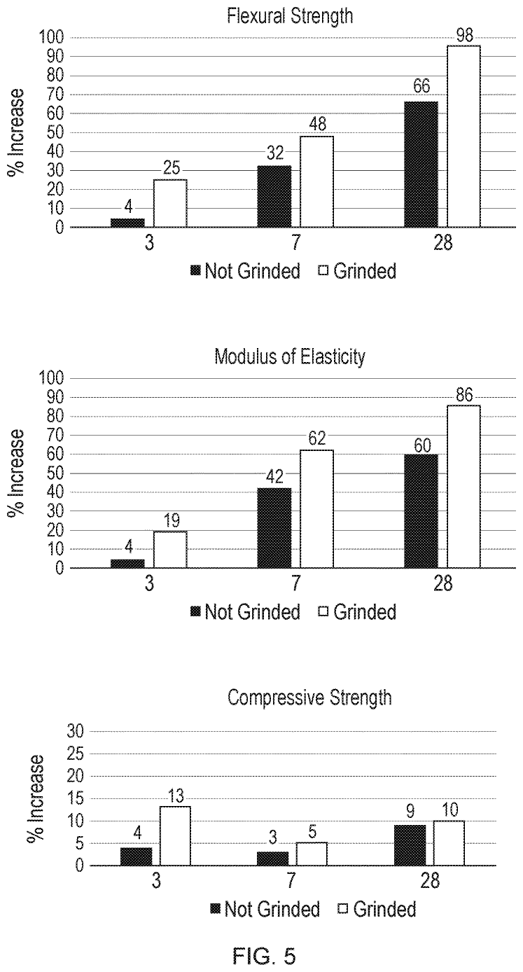

As illustrated in FIG. 6, five SEM images were obtained at 15 KX, 25 KX and 50 KX magnifications after 7 days of curing. As shown in the top left SEM, the CNTs are disentangled, forming a three-dimensional mesh in contact with the cement particles. The nanotubes integrate into the cementitious matrix, becoming embedded in calcium silicate gels (see the top middle SEM) and allowing the bridging of cement particles (see the top right SEM). The CNTs also begin to fill the interparticle spaces of the cement, contributing to reduced porosity (see the bottom two SEMs).

It has been determined that the disaggregation, dispersion, and integration of the CNTs into the cementitious material significantly enhances its durability, compressive strength, flexural strength, and elasticity properties, demonstrating the technical effect achieved by grinding the CNT-metal hydroxide hybrid material before incorporation into the cement, as described herein.

### Example 6: Mechanical Properties of Mortar Samples Prepared Using Different MWCNT Loadings in Cement

The present example demonstrates technical effects achieved by incorporating carbon nanotubes (MWCNTs) into cement. Mortar specimens were prepared with varying MWCNT loadings to illustrate the improvement in mechanical properties. A hybrid material composed of MWCNT-Al₂O₃ containing 83 wt % MWCNT was employed and blended with cement powder in proportions ranging from 0.05 wt % to 0.55 wt %. Flexural strength, modulus of elasticity, and compressive strength were evaluated after 3, 7, and 28 days of curing, using Portland Type I/II cement in all samples.

Specimens were prepared by initially blending the cement powder with the pre-ground hybrid material, according to the procedure described in Example 3, followed by the addition of standard sand (ASTM C778-17) as aggregate and water in the following ratios: water-to-cement ratio (w/c)=0.5 and sand-to-cement ratio (s/c)=2.75. Mixing was conducted in accordance with ASTM C305-20 using a robust standard mixer capable of operating between 140±5 rpm and 285±10 rpm. The blended mortars were cast in oiled molds of 20×20×80 mm³ and 20×20×40 mm³ for mechanical testing.

Table 1 summarizes the flexural strength, modulus of elasticity, and compressive strength of mortars prepared with different MWCNT loadings, with results reported relative to control mortars without carbon nanotubes. These results establish that the hybrid MWCNT-metal hydroxide material is effective to improve the mechanical properties of mortars at almost any loading level, from 0.05 wt % CNT up to 0.55 wt %.

TABLE 1
Flexural strength, modulus of elasticity, and compressive strength
of mortars prepared with different MWCNT loadings
(reported as weight percent) at 3, 7 and 28 days curing times.

| Flexural Strength | 3 days | 7 days | 28 days |
|---|---|---|---|
| 0.05 MWCNT | 13% | 16% | 24% |
| 0.075 MWCNT | 17% | 21% | 31% |
| 0.10 MWCNT | 25% | 28% | 44% |
| 0.15 MWCNT | 28% | 32% | 49% |
| 0.30% MWCNT | 37% | 42% | 63% |
| 0.55% MWCNT | 33% | 36% | 55% |
| Modulus of Elasticity | 3 days | 7 das | 28 days |
| 0.05 MWCNT | 11% | 14% | 17% |
| 0.075 MWCNT | 15% | 18% | 22% |
| 0.10 MWCNT | 23% | 26% | 31% |
| 0.15 MWCNT | 27% | 31% | 36% |
| 0.30% MWCNT | 35% | 41% | 51% |
| 0.55% MWCNT | 30% | 35% | 43% |
| Compressive Strength | 3 days | 7 days | 28 days |
| 0.05 MWCNT | 3% | 5% | 8% |
| 0.075 MWCNT | 4% | 6% | 10% |
| 0.10 MWCNT | 4% | 6% | 11% |
| 0.15 MWCNT | 6% | 9% | 13% |
| 0.30% MWCNT | 10% | 13% | 18% |
| 0.55% MWCNT | 11% | 15% | 18% |

It was observed that the incorporation of MWCNTs into cement provides a significant improvement in mechanical properties. Maximum enhancement was achieved at a MWCNT content of 0.30 wt %. For higher loadings, up to 0.55 wt % MWCNT, a notable decrease in workability was observed, resulting in a reduction in the improvement of flexural strength and modulus of elasticity. However, compressive strength remained essentially constant across the range of 0.30 wt % to 0.55 wt % MWCNT, demonstrating that the incorporation of carbon nanotubes provides a sustained technical effect on the load-bearing capacity of the mortar.

The results confirm that the pre-conditioning and incorporation of MWCNTs into cement as described herein provides enhanced mechanical performance compared to conventional mortars without CNTs.

### Example 7: Variation in Mortar Workability when Integrating a Hybrid MWCNT-Al₂O₃ Material at Different Levels into Cement Powder

This example illustrates the effect of incorporating a hybrid MWCNT-Al₂O₃ material, containing 73 wt % MWCNT, on the workability of mortar, thereby demonstrating a technical limitation and effect achieved through the use of carbon nanotubes. Workability was assessed relative to a control mortar without MWCNTs.

Table 2 summarizes the observed reduction in workability (measured using the mini-slump test) for cement mixtures containing MWCNT loadings ranging from 0.20 wt % to 0.55 wt %. A significant decrease in workability is observed when the MWCNT content exceeds approximately 0.30 wt %, indicating that higher concentrations of carbon nanotubes in cement adversely affect the flow and handling properties of the mortar mixture.

These results highlight the importance of controlling the MWCNT content within cementitious compositions to achieve the desired balance between enhanced mechanical performance and acceptable workability. This is one technical consideration in the preparation of CNT-reinforced cement mortars.

TABLE 2

| Reduction in mortar workability as a function . | |
|---|---|
| of MWCNT content in cement | |
| MWCNT content in | Workability |
| cement (wt %) | decrease (%) |
| 0.20 | 4 |
| 0.30 | 15 |
| 0.40 | 20 |
| 0.55 | 26 |

### Example 8: Mechanical Properties of Mortar as a Function of the MWCNT Content in the CNT-Al₂O₃ Hybrid Material

This example demonstrates the variation in the mechanical properties of mortar as a function of the MWCNT content in the hybrid material, which ranged from 55 wt % to 83 wt %. In all preparations, the MWCNT content in the cement was maintained at 0.30 wt %. The results of the mechanical tests conducted at different curing times are presented in Table 3.

An increase in flexural strength and modulus of elasticity was observed with increasing MWCNT content in the hybrid material, showing a progressive improvement from 55 wt % to 73 wt % MWCNT, and then remaining essentially constant for the sample containing 83 wt % MWCNT. In contrast, the highest enhancement in compressive strength was achieved when the hybrid material contained 83 wt % MWCNT.

These results demonstrate that the MWCNT content in the hybrid material can be optimized to maximize specific mechanical properties, providing a technical effect that can be tailored according to the desired performance characteristics of CNT-reinforced cement mortars.

TABLE 3
Mechanical properties of mortars with hybrid
materials of varying MWCNT loadings at
3, 7, and 28 days of Curing

| Flexural Strength | 3 days | 7 days | 28 days |
|---|---|---|---|
| 55% MWCNT | 29% | 34% | 49% |
| 64% MWCNT | 31% | 36% | 54% |
| 73% MWCNT | 39% | 43% | 65% |
| 83% MWCNT | 37% | 42% | 63% |
| Modulus of Elasticity | 3 days | 7 days | 28 days |
| 55% MWCNT | 28% | 31% | 41% |
| 64% MWCNT | 30% | 34% | 44% |
| 73% MWCNT | 38% | 42% | 53% |
| 83% MWCNT | 35% | 41% | 51% |
| Compressive Strength | 3 days | 7 days | 28 days |
| 55% MWCNT | 6% | 12% | 15% |
| 64% MWCNT | 8% | 13% | 16% |
| 73% MWCNT | 8% | 10% | 13% |
| 83% MWCNT | 10% | 13% | 18% |

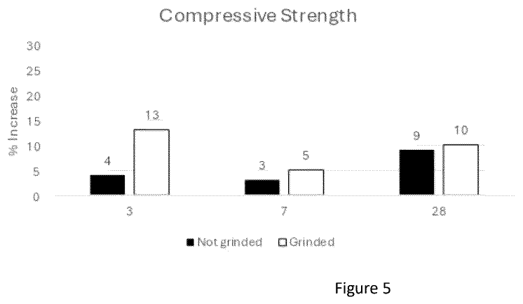

Four SEM images taken at 5 KX magnification (FIG. 7) revealed variations in the morphology and aspect ratio of the CNTs as a function of their content in the hybrid material. Cotton-ball-like structures and short CNTs were observed in the hybrid material containing 55 wt % CNTs (top left). As the MWCNT content in the hybrid material increased (64%, top right SEM; 73% bottom left SEM), the formation of long CNT bundles became evident. In particular, the sample containing 83 wt % CNTs (bottom right SEM) exhibited bundles with lengths exceeding 10 microns.

These observations demonstrate that the MWCNT content in the hybrid material directly influences the structural characteristics of the CNTs, which in turn affects their integration, dispersion, and mechanical reinforcement in cementitious composites.

### Example 9: Mechanical Strength Improvement by CNTs Using Different Commercial Cements

In this example, two types of commercial cement (OPC Type I, and Ashgrove IL) were used. The hybrid material contained 83 wt % MWCNT, and the MWCNT content in the cement was maintained at 0.30 wt %. The mechanical properties, measured after 3, 7, and 28 days of curing, are summarized in Table 4.

As shown, the enhancements in flexural strength, modulus of elasticity, and compressive strength of mortars prepared with the different commercial cement are comparable to those reported in Tables 1 and 3.

TABLE 4
Mechanical properties of mortars prepared with different
commercial cement containing 0.30 wt % MWCNT in cement.

| 3 Days Curing | OPC-1 | Ashgrove Type 1L |
|---|---|---|
| Flexural Strength | 39% | 37% |
| Modulus of Elasticity | 38% | 34% |
| Compressive Strength | 10% | 8% |
| 7 Days Curing | OPC-1 | Ashgrove Type 1L |
| Flexural Strength | 43% | 39% |
| Modulus of Elasticity | 41% | 39% |
| Compressive Strength | 13% | 13% |
| 28 Days Curing | OPC-1 | Ashgrove Type 1L |
| Flexural Strength | 66% | 59% |
| Modulus of Elasticity | 52% | 48% |
| Compressive Strength | 19% | 16% |

### Example 10: Influence of the CNT Aspect Ratio in the Hybrid Material on Mechanical Strength Properties of Mortar

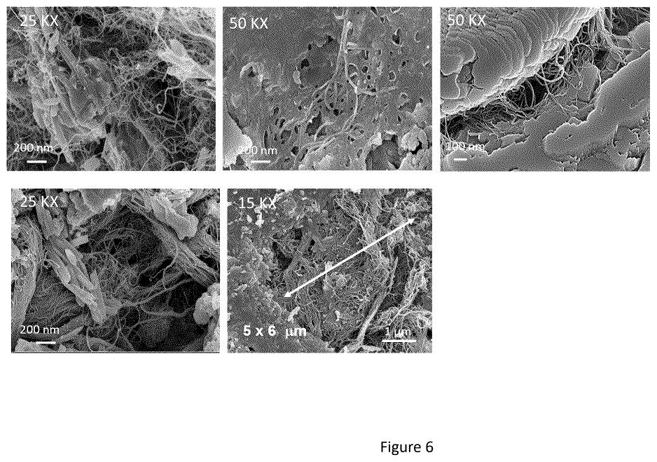

In this example, mortars were prepared from hybrid materials containing 83 wt % and 85 wt % MWCNTs, with 0.30 wt % CNT in cement, and differing in aspect ratio. SEM images of the as-produced materials showed that the hybrid containing 85 wt % MWCNT (right side SEM, FIG. 8) exhibited long carbon nanotube bundles exceeding 20 μm in length and 3-5 μm in diameter. In contrast, the hybrid containing 83 wt % MWCNT (left side SEM, FIG. 8) showed bundles with lengths of 10-15 μm and diameters of 1-3 μm (FIG. 8).

The tap bulk densities of the as-produced materials were 0.0772 g/cc for the 85 wt % MWCNT hybrid and 0.0499 g/cc for the 83 wt % MWCNT hybrid. After grinding, the tap bulk densities decreased to 0.0106 g/cc and 0.102 g/cc, respectively.

The Raman G/D ratios for the as-produced CNT-Al₂O₃ hybrid materials containing 83 wt % MWCNT and 85 wt % MWCNT were determined using 532 nm and 638 nm lasers. For the 83 wt % sample, the G/D ratios were 1.128 (532 nm) and 0.857 (638 nm). For the 85 wt % sample, the corresponding values were 0.946 (or, at least about 0.9) (532 nm) and 0.686 (or, at least about 0.7) (638 nm).

The mechanical properties of these samples were evaluated after 3, 7, and 28 days of curing. As shown in Table 5, the sample containing 83 wt % MWCNT in the hybrid material (with carbon nanotube bundles 10-15 μm in length and 1-3 μm in diameter) exhibited greater improvements in mechanical properties compared to the 85 wt % MWCNT sample.

TABLE 5

| Mechanical properties of mortars prepared with | | | |
|---|---|---|---|
| different MWCNT hybrid materials, showing variations | | | |
| in CNT bundle aspect ratios at 3, 7 and 28 days curing. | | | |
| 85 wt % MWCNT in hybrid | 3 days | 7 days | 28 days |
| Flexural Strength | 8% | 10% | 17% |
| Modulus of Elasticity | 7% | 9% | 9% |
| Compressive Strength | 8% | 10% | 14% |
| 83 wt % MWCNT in hybrid | 3 | 7 | 28 |
| Flexural Strength | 37% | 42% | 63% |
| Modulus of Elasticity | 35% | 41% | 51% |
| Compressive Strength | 10% | 13% | 18% |

### Example 11: Evaluation of Mixing Methods for CNT-Al₂O₃/Cement Composites

The CNT-Al₂O₃ hybrid material was previously ground according to the procedure described in Example 3. Mixing with the cement powder was performed using a high-speed mixer at 1250 rpm for one minute, followed by mixing in a conventional mortar mixer at 24 rpm for 30 minutes. The hybrid material contained 72 wt % MWCNT, corresponding to a concentration of 0.20 wt % in the mixture with commercial Quikrete Type I/II cement.

Table 6 presents the mechanical properties measured after 3, 7, and 28 days of curing. No significant differences were observed between the samples prepared using the two mixing methods, indicating that mechanically preconditioning the hybrid material particles facilitates subsequent mixing with cement. This preconditioning reduces the energy required to integrate the carbon nanotubes into the cement, allowing the use of conventional mixing equipment.

TABLE 6
Performance of Mortars Prepared Using Different Mixing Equipment

| High Speed Mixer | 3 days | 7 days | 28 days |
|---|---|---|---|
| Flexural Strength | 53% | 53% | 76% |
| Modulus of Elasticity | 47% | 48% | 57% |
| Compressive Strength | 12% | 13% | 15% |
| Mortar Mixer | 3 days | 7 days | 28 days |
| Flexural Strength | 51% | 52% | 74% |
| Modulus of Elasticity | 46% | 47% | 55% |
| Compressive Strength | 12% | 12% | 14% |

| Compressive Strength | 7 Days | 28 Days |
|---|---|---|
| Rotating V-Cone Blender | - | 15% |
| Paddle Blender | 23 % | - |

### Example 12: Comparative Performance of High-Purity CNTs and CNT-Metal Oxide Hybrids in Cement Reinforcement

In this example, the carbon nanotube sample containing 83 wt % purity described in Example 8 was subjected to chemical purification (to remove the catalyst particles) using a mixture of hydrochloric and sulfuric acids, each at a molarity of 1.5 M, under reflux conditions for 5 hours. After purification, the carbon purity increased to 99%. The purified material was then ground using a blade grinder and mixed with cement powder (0.10 wt % CNT in cement) following the same procedure described in Example 3.

A second CNT-cement mixture was also prepared using the purified material without grinding, maintaining a CNT loading of 0.10 wt % MWCNT, and this sample was used as a reference.

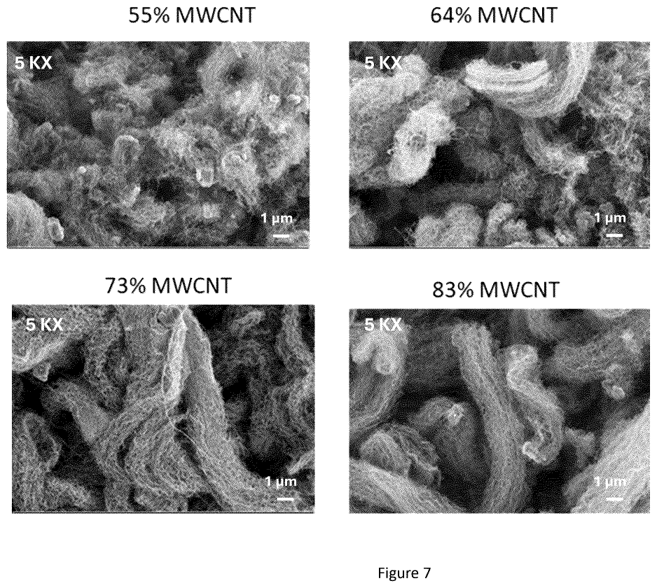

FIG. 9 shows SEM images at 500×, 1,000×, and 5,000× magnification (left to right, respectively) of the purified samples, both before grinding (top row) and after grinding (bottom row). Comparison of the SEM images of the as-produced sample with 83 wt % carbon purity (FIGS. 7 and 8) and the purified sample (FIG. 9) reveals clear changes in material morphology. The as-produced sample exhibits CNT bundles, whereas the purified sample shows fewer bundles and the formation of compact, irregular structures. After mechanical grinding of the purified material, the morphology transitions to irregular aggregates of MWCNT bundles.

These morphological changes arise because removal of catalyst particles eliminates the physical interactions that help maintain the bundled structure of the nanotubes. High-purity CNTs therefore present a disadvantage for use in cement and concrete compared to CNT-metal oxide hybrid materials, as they exhibit a higher degree of aggregation and entanglement, which negatively affects improvements in cement mechanical properties.

The mechanical test results presented in Table 7 are consistent with the observations obtained from the SEM analyses of the purified samples. After 3 days of curing, a loss of flexural strength and elastic modulus is observed when the catalyst particles in the hybrid material are removed through chemical purification methods. However, the compression strength results were positive, showing improvements between 2% and 3%.

Separated CNT particles were also observed outside the cement matrix in both high-purity samples after mixing. The milled material exhibited a smaller loss in mechanical properties compared to the purified material that was not milled. The “as-produced” material exhibited a tap bulk density of 0.0520 g/cc, while the purified and subsequently milled samples exhibited tap bulk density values of 0.0677 g/cc and 0.0564 g/cc, respectively.

TABLE 7

| Mechanical strength properties comparing the MWCNT | |
|---|---|
| hybrid material as produced with the same | |
| material after purification and subsequent grinding. | |
| As Produced | 3 days curing |
| Flexural Strength | 25 |
| Modulus of Elasticity | 23 |
| Compressive Strength | 4 |
| Purified | 3 days curing |
| Flexural Strength | -11 |
| Modulus of Elasticity | -10 |
| Compressive Strength | 2 |
| Purified and Ground | 3 days curing |
| Flexural Strength | -3 |
| Modulus of Elasticity | -2 |
| Compressive Strength | 3 |

### Example 13: Effect of Ball Milling on the Morphology and Mechanical Performance of CNT-Al₂O₃Hybrid Materials in Cement Composites

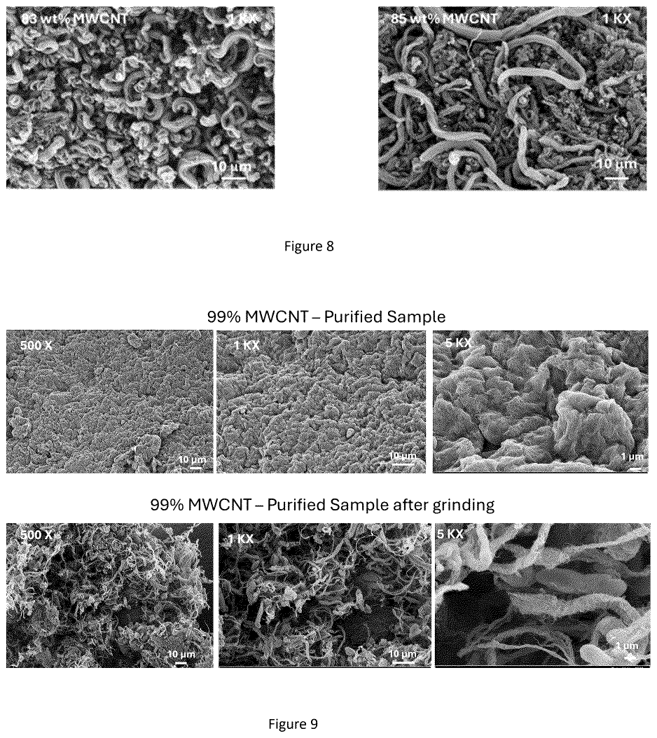

In this example, the CNT-Al₂O₃ hybrid material, previously ground using a bladed grinder, was subjected to an additional milling step in a ball mill with the objective of further reducing the aspect ratio of the carbon nanotubes and evaluating the resulting changes in mechanical performance. SEM images acquired at 10 kx (top row of 3 SEM images), 15 kx (bottom left SEM), 20 kx (bottom middle SEM), and 25 kx (bottom right SEM) magnification for the ground and ball-milled material—after being mixed with cement particles in a high-speed mixer at a loading of 0.20 wt % MWCNT—are presented in FIG. 10.

The images show a clear reduction in CNT bundle length to below 10 μm. Most bundles exhibit lengths between 2 and 8 μm and diameters between 0.5 and 2 μm. Additionally, compact, cotton-ball-like CNT agglomerates were observed.

Table 8 summarizes the mechanical properties of the hybrid material that was first ground using a blade-type grinder and subsequently milled in a ball mill for 10 minutes. When comparing the flexural strength, elastic modulus, and compressive stress of the sample that was ground and then ball-milled, a clear reduction in the mechanical performance improvement of the cement is observed. The aspect ratio of the CNT bundles decreased for the sample treated in the ball mill (see FIG. 10). Also, the tap bulk density of these particles increased significantly compared with both the as-produced material and the material processed only by blade grinding (see Table 9). The increased tap bulk density is attributed to the compaction of the CNT bundles during the ball milling process.

TABLE 8
Mechanical properties of the CNT-Al₂O₃
hybrid material after grinding and ball milling.

| Ground | 3 days | 7 days | 28 days |
|---|---|---|---|
| Flexural Strength | 53 | 53 | 76 |
| Modulus of Elasticity | 47 | 48 | 57 |
| Compressive Strength | 12 | 13 | 15 |
| Ground and Ball Milled | 3 days | 7 days | 28 days |
| Flexural Strength | 40 | 42 | 58 |
| Modulus of Elasticity | 40 | 41 | 47 |
| Compressive Strength | 9 | 10 | 12 |

TABLE 9

| Effect of Grinding and Ball Milling on the Tap Bulk | |
|---|---|
| Density of the CNT-Cement Hybrid Material | |
| | Tap Bulk Density (g/cc) |
| CNT-Al₂O₃ hybrid as produced | 0.073 |
| After Blade Grinding | 0.017 |
| After subsequent Ball Milling | 0.231 |

### Example 14: Effect of Mechanical Pre-Conditioning on the Raman G/D Ratio of CNT-Al₂O₃ Hybrid Material

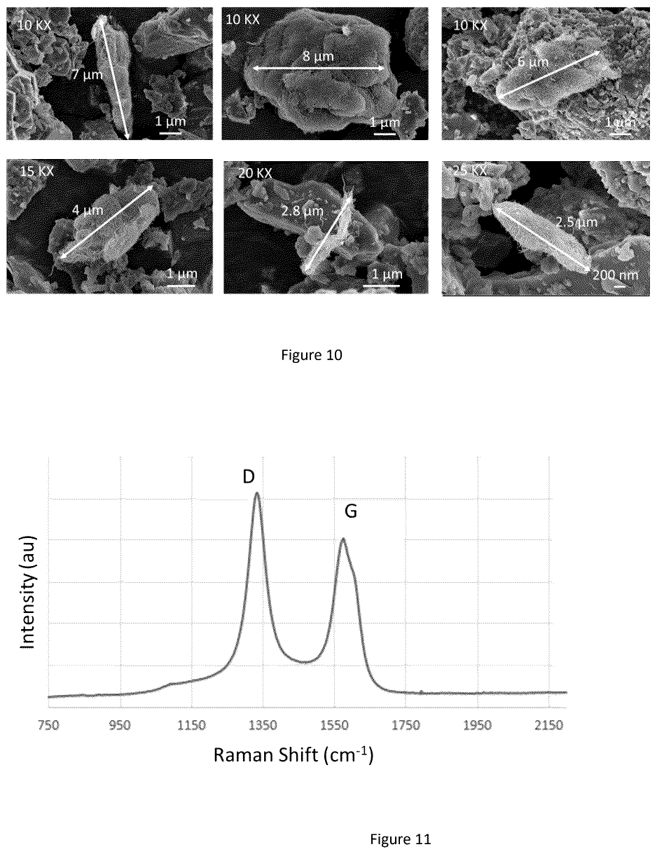

In this example, the effect of using different mechanical pre-conditioning methods on the structural properties of carbon nanotubes in the hybrid material was investigated. Raman spectroscopy was used to evaluate these effects, as this technique provides information on structural defects and the presence of other carbon species through the intensity ratio of the G and D bands obtained with both 532 nm and 638 nm lasers. The G band, located at approximately 1580 cm⁻¹, is characteristic of tubular carbon, while the D band, located at approximately 1340 cm⁻¹, corresponds to structural defects or amorphous carbon (FIG. 11).

Table 10 presents the Raman analysis results for the CNT-Al₂O₃ hybrid material containing 72 wt % MWCNT, comparing the “as-produced” sample with samples ground using different types of grinders. The results show that the G/D ratio is highest for the as-produced material and decreases as mechanical treatments are applied. The smallest reduction in the G/D ratio is observed when using a blade grinder, whereas the largest reduction occurs when a ball mill is employed. Aggressive mechanical treatments, such as ball milling, tend to reduce the aspect ratio of the nanotubes and generate small carbon fragments, which do not contribute significantly to improving the mechanical properties of cement.

In the case of the dry burst grinder, SEM analysis shows compaction of the material after mechanical pre-conditioning, as well as breakage of the carbon nanotubes.

TABLE 10
Raman Analysis of CNT-Al₂O₃ Hybrid Material
After Mechanical Pre-Conditioning

| Grinder type | G/D (532 nm) | G/D (638 nm) |
|---|---|---|
| Not ground | 1.128 | 0.857 |
| Blade grinder | 1.096 | 0.848 |
| Dry burst grinder | 1.075 | 0.796 |
| Ball mill of material as | 1.047 | 0.776 |
| produced | | |

### Example 15: Effect of Grinding Conditions on Tap Bulk Density of CNT-Al₂O₃ Hybrid Material

In this example, the effect of grinding conditions on the tap bulk density of the hybrid material, which contains 72 wt % CNTs and 85 wt % CNTs was investigated. A blade-type grinder was used in the experiments, and the grinding time was progressively varied from 2 to 20 minutes.

Table 11 includes the tap bulk density results obtained for the hybrid materials containing 72 wt % CNTs and 85 wt % CNTs at different grinding times. Both as-produced materials exhibit similar tap bulk density values (0.0728 g/cc and 0.0745 g/cc, respectively). When both materials are ground, a progressive decrease in tap bulk density is observed as a function of grinding time.

For the material containing 72 wt % CNTs, a minimum value of approximately 0.0169 g/cc is reached after 12 minutes of grinding. This equates to a decrease of about 78%. Increasing the grinding time beyond this point does not lead to further changes in tap bulk density.

For the hybrid material containing 85 wt % CNTs, the minimum tap bulk density value of approximately 0.0091 g/cc is obtained after 6 minutes of grinding. This equates to a decrease of about 88%. For longer grinding times, the tap bulk density is only slightly reduced, to 0.0089 g/cc.

TABLE 11

| Effect of Grinding Time on Tap Bulk | | |
|---|---|---|
| Density of the Hybrid CNT Material | | |
| | Tap Bulk | Tap Bulk |
| Grinding | Density (g/cc) | Density |
| time | 72 wt % | (g/cc) 85 wt % |
| (minutes) | CNTs | CNTs |
| Not ground | 0.0728 | 0.0745 |
| 2 | 0.0411 | 0.0129 |
| 6 | 0.0195 | 0.0091 |
| 12 | 0.0169 | 0.0092 |
| 16 | 0.0166 | 0.0091 |
| 20 | 0.0160 | 0.0089 |

### Example 16: Concrete

In this example, the hybrid material (72 wt % MWCNT) was dry-blended with commercial OPC Type I cement powder at a loading of 0.10 wt % MWCNT, and concrete specimens were prepared by mixing the CNT-cement blend with fine (sand) and coarse (gravel) aggregates in an industrial paddle blender. Water and superplasticizer were added to adjust the workability. At 7 days, the specimen containing the hybrid material exhibited a 4% increase in compressive strength compared to the corresponding control concrete specimen.

Permeability tests were performed using the chloride ion penetration method (ASTM C1202). The control concrete showed a value of 1,444 Coulombs, whereas the concrete specimen with the CNT-cement blend showed 309 Coulombs. This as a significant enhancement over the control sample.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An additive material for mortar or concrete, comprising:
dry powder hybrid multiwall carbon nanotube (MWCNT)-metal oxide material, comprising:
from about 50% to about 90% by weight MWCNT comprising MWCNT bundles having lengths between about 5 microns and 50 microns and diameters between about 0.5 microns and about 5 microns, the bundles comprising individual MWCNTs having diameters from about 7 nm to about 30 nm; and
from about 10% to about 50% by weight metal oxide particles;
wherein the dry powder hybrid MWCNT-metal oxide material has a tap bulk density of less than about 0.090 g/cc.

2. The additive material of claim 1 wherein the metal oxide comprises alumina.

3. The additive material of claim 2 wherein the alumina comprises nano-alumina particles.

4. The additive material of claim 1 wherein the dry powder hybrid MWCNT-metal oxide material comprises from about 70% to about 85% MWCNT.

5. The additive material of claim 1 wherein the MWCNT bundles have lengths between about 10 microns and 25 microns.

6. The additive material of claim 1 wherein the MWCNT bundles have diameters between about 1 micron and about 3 microns.

7. The additive material of claim 1 wherein the individual MWCNTs having diameters from about 8 nm to about 15 nm.

8. The additive material of claim 1 further comprising dry cement powder.

9. The additive material of claim 8 wherein the dry cement powder is mixed with the dry powder hybrid MWCNT-metal oxide material, and then mixed with sand and water, to create a mortar, wherein the amount of the dry powder hybrid MWCNT-metal oxide material in the mortar is from about 0.05 wt % to about 0.55 wt %.

10. The additive material of claim 9 wherein the mixture is effective to improve at least one of the flexural strength, the modulus of elasticity and the compressive strength of mortar prepared with the additive material as compared to mortar without the additive material.

11. The additive material of claim 1 wherein the tap bulk density of the dry powder hybrid MWCNT-metal oxide material is less than about 0.040 g/cc.

12. The additive material of claim 11 wherein the tap bulk density of the dry powder hybrid MWCNT-metal oxide material is between about 0.0195 g/cc and about 0.0089 g/cc.

13. The additive material of claim 1 wherein the additive material has a Raman spectroscopy G/D ratio of at least 0.90 using a 532 nm laser and at least 0.70 using a 638 nm laser.

14. The additive material of claim 1 comprising from about 15% to about 30% by weight metal oxide particles.

15. A method for integrating carbon nanotubes (CNT) into cement matrices, comprising:
synthesizing multi-wall CNT (MWCNT) using catalysts containing one or more active metals selected from the group of metals including Co, Fe, and Mo supported on a metal-oxide based support and using carbon-containing gas as a carbon source in a rotary tube or fluidized bed reactor;
preconditioning a dry powder comprising the synthesized MWCNT by a mechanical dry milling process, to deagglomerate and disentangle the synthesized MWCNT, to form more open structures; and
dry mixing the preconditioned MWCNT with dry cement particles;
wherein the preconditioned MWCNTs are more readily dispersed into a cement matrix, with less energy required to de-bundle and disperse the preconditioned MWCNTs into the cement matrix as compared to the original MWCNTs before preconditioning.

16. The method of claim 15, wherein the mixture of the preconditioned MWCNT with cement particles has improved mechanical properties as compared to mortar, wherein the improved mechanical properties include one or more of the flexural strength, the modulus of elasticity, and the compressive strength.

17. The method of claim 15, wherein the metal-oxide based support comprises one or more of alumina, MgO—Al₂O₃, and SiO₂—Al₂O₃.

18. The method of claim 17, wherein the metal-oxide based support has a specific surface area of from about 200 to about 400 m²/g.

19. The method of claim 15, wherein the synthesized MWCNT has a bundle morphology.

20. The method of claim 15, wherein the preconditioned dry powder comprising the synthesized MWCNT has a tap bulk density of less than about 0.02 g/cc.

21. The method of claim 20 wherein the preconditioned dry powder comprising the synthesized MWCNT has a Raman spectroscopy G/D ratio of at least 0.90 using a 532 nm laser and at least 0.70 using a 638 nm laser.

22. The method of claim 15, wherein the mechanical dry milling process comprises an industrial powder grinding method.
